(19) United States
(12) Patent Application Publication
(10) Pub. No.: US 2023/0050570 A1
(43) Pub. Date: Feb. 16, 2023

(54) Exercise Method and Equipment

(71) Applicant: Suijimanbu (Shanghai) Sports Technology Co., Ltd., Shanghai (CN)

(72) Inventor: Cheng Chen, Shanghai (CN)

(73) Assignee: Suijimanbu (Shanghai) Sports Technology Co., Ltd., Shanghai (CN)

(21) Appl. No.: 17/466,116

(22) Filed: Sep. 3, 2021

(30) Foreign Application Priority Data
Aug. 13, 2021 (CN) 202110930530.6

(51) Int. Cl. A63B 71/06; G06T 13/20; G06T 13/40; G06T 13/80; G06K 9/00; A63B 24/00; A63B 22/06

(52) U.S. Cl. CPC A63B 71/0622; G06T 13/205; G06T 13/40; G06T 13/80; G06K 9/00342; A63B 24/0062; A63B 22/0605; A63B 24/0075; A63B 2071/0638; A63B 2071/068; A63B 2220/833

(57) ABSTRACT

An exercise method and an exercise equipment are provided. The exercise method includes: determining an exercise guiding video according to a selected music input/audio signal, wherein the exercise guiding video includes a first exercise guiding video and/or a second exercise guiding video, the first exercise guiding video is a live video automatically generated according to the selected music input/audio signal, the second exercise guiding video is a video previously recorded according to the selected music input/audio signal; generating CGA and special-effect/animated feedbacks corresponding to the music information/audio signal and instruction/cuing in the exercise guiding video; playing the exercise guiding video, the CGA, the special-effect/animated feedbacks and the selected music input/audio signal on a display and computing device; receiving user performance data; displaying interactive feedback data on the display and computing device, according to a result obtained by matching the user performance data with music information/audio signal analyzed from selected music input/audio signal.

### CROSS-REFERENCE TO RELATED APPLICATIONS

This application claims priority to Chinese Patent Application No. 202110930530.6, filed on Aug. 13, 2021, the entire contents of which are incorporated herein by reference.

### TECHNICAL FIELD

The present disclosure relates to intelligent exercise technology, and more particularly to an exercise method and an exercise equipment.

### BACKGROUND

Various exercise methods have been developed for pursuing of a healthier lifestyle and improved physical condition. Exercise at home is more convenient than other exercise modes and has been more and more popular. Users can exercise under the guidance of an instructor video by playing a previously recorded instructor video.

The exercise movements in the instructor video are generally related to instructions from an instructor. The users exercise following the movement guidance and the instructions in the instructor video. Therefore, the exercise mode lacks the ability to attract the users, and the exercise process is relatively monotonous.

Therefore, technical problems exist in the field of how to adjust and optimize the exercise method and the exercise equipment to provide live/streamed videos having a combination of multi-layer having various dynamic elements for exercise guidance, and how to provide interactive feedback data according to the user performance data to improve the interactive experience and engagement of the users.

### SUMMARY

In one aspect of the present disclosure, an exercise method is provided, wherein the exercise method includes: determining an exercise guiding video according to a selected music input/audio signal, wherein the exercise guiding video includes a first exercise guiding video and/or a second exercise guiding video, the first exercise guiding video is a live video automatically generated according to the selected music input/audio signal, the second exercise guiding video is a video previously recorded according to the selected music input/audio signal; generating CGA (Computer Generated Animation) and special-effect/animated feedbacks corresponding to the music information/audio signal and instruction/cuing in the exercise guiding video; playing the exercise guiding video, the CGA, the special-effect/animated feedbacks and the selected music input/audio signal on a display and computing device; receiving user performance data; displaying interactive feedback data on the display and computing device, according to a result obtained by matching the user performance data with music information/audio signal analyzed from selected music input/audio signal.

In another aspect of the present disclosure, an exercise equipment is provided, wherein the exercise method includes: an exercise bike provided with multiple bike sensor devices, wherein the bike sensor devices are configured to track and collect user performance data; a display and computing device configured to play videos and audios, and process programs and algorithms; a control device configured to: receive an exercise guiding video determined according to a selected music input/audio signal, wherein the exercise guiding video includes a first exercise guiding video and/or a second exercise guiding video, the first exercise guiding video is a live video generated automatically according to the selected music input/audio signal, the second exercise guiding video is a video previously recorded according to the selected music input/audio signal; receive CGA and special-effect/animated feedbacks; control the display and computing device to display the exercise guiding video, the CGA, the special-effect/animated feedbacks and the selected music input/audio signal; receive the user performance data from the bike sensor devices; receive interactive feedback data generated or updated according to a result obtained by matching the user performance data with music information/audio signal analyzed from selected music input/audio signal; control the display and computing device to display the interactive feedback data.

In another aspect of the present disclosure, an exercise equipment is provided, wherein the exercise method includes: a first exercise device provided with first sensor devices, wherein the first sensor devices are configured to track and collect first user performance data; a second exercise device provided with second sensor devices, wherein the second sensor devices are configured to track and collect second user performance data; a display and computing device configured to play videos and audios, and process programs and algorithms; a control device configured to: receive an exercise guiding video determined according to a selected music input/audio signal, wherein the exercise guiding video includes a first exercise guiding video and/or a second exercise guiding video, the first exercise guiding video is a live video generated automatically according to the selected music input/audio signal, the second exercise guiding video is a video previously recorded according to the selected music input/audio signal; receive CGA and special-effect/animated feedbacks; control the display and computing device to display the exercise guiding video, the CGA, the special-effect/animated feedbacks and the selected music input/audio signal; determine whether a first exercise mode or a second exercise mode is selected, according to a rotation angle of the display and computing device; if the first exercise mode is selected: receive the first user performance data from the first sensor devices; receive first interactive feedback data generated or updated according to a matching and analyzing result between the first user performance data and music information/audio signal of the selected music input/audio signal; control the display and computing device to display the first interactive feedback data; if the exercise mode is the second exercise mode: receive the second user performance data from the first sensor devices; receive second interactive feedback data generated or updated according to a matching and analyzing result between the second user performance data and music information/audio signal of the selected music input/audio signal; control the display and computing device to display the second interactive feedback data.

### BRIEF DESCRIPTION OF THE DRAWINGS

The foregoing and other features, and advantages of the invention are apparent from the following detailed description taken in conjunction with the accompanying drawings in which:

FIG. 1 is a schematic diagram of an exercise equipment according to an embodiment of the present disclosure;

FIG. 2 is a schematic diagram of an exercise equipment according to another embodiment of the present disclosure;

FIG. 3 is a flow chart of an exercise method according to an embodiment of the present disclosure;

FIG. 4 is a schematic view of a display interface of a display and computing device according to an embodiment of the present disclosure;

FIG. 5 is a flow chart of generating a first exercise guiding video according to an embodiment of the present disclosure;

FIG. 6 is a flow chart of generating a movement instruction sequence according to an embodiment of the present disclosure;

FIG. 7 is a flow chart of generating a second exercise guiding video according to an embodiment of the present disclosure;

FIG. 8 is a flow chart of generating a CGA including special-effect/animated feedbacks according to an embodiment of the present disclosure;

FIG. 9 is a flow chart of providing interactive feedback according to an embodiment of the present disclosure;

FIG. 10 is a flow chart of displaying a leaderboard display area according to an embodiment of the present disclosure;

FIG. 11 is a schematic view of a display interface including the leaderboard display area on a display and computing device according to an embodiment of the present disclosure;

FIG. 12 is a block diagram of an exercise server according to an embodiment of the present disclosure.

### DETAILED DESCRIPTION

In the following, embodiments of the present disclosure will be described in detail with reference to the figures. The concept of the present disclosure can be implemented in a plurality of forms, and should not be understood to be limited to the embodiments described hereafter. On the contrary, these embodiments are provided to make the present disclosure more comprehensive and understandable, and so the conception of the embodiments can be fully conveyed to those skilled in the art. Same reference signs in the figures refer to same or similar elements, so a repeated description of them will be omitted.

Besides, the technical features, assemblies, and characteristics can be combined in any appropriate way in one or more embodiments. In the following, more specific details are provided to give a full understanding of the embodiments of the present disclosure. However, those skilled in the art should realize that the technical proposal can also be realized without one or more of the specific details, or with other assemblies or components. In other conditions, some common assemblies or components well known in the art are not described to avoid making the present disclosure unclear. Some blocks in the block diagram represent functional entities and maybe not in correspondence to physical or logical individual entities. The functional entities can be realized using software, or using one or more hardware modules or integrated modules, or using different networks and/or processors and/or micro controllers.

The flow charts only schematically show the method and may not include all the steps. For example, some steps can be further separated into a plurality of sub-steps, and some steps can be combined fully or partially. Besides, the executing sequence of the steps is not limited to the sequence shown in the flow charts and may be changed according to actual requirements.

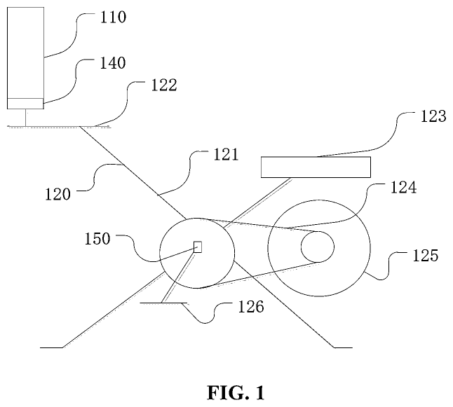

FIG. 1 is a schematic diagram of an exercise equipment according to an embodiment of the present disclosure. As shown in FIG. 1, the exercise equipment includes a display and computing device 110, an exercise bike 120, and a control device 140.

In the embodiment, the display and computing device 110 is a display screen facing the exercise bike 120 and configured to play videos and audios, and process programs and algorithms. In some other embodiments, the display and computing device 110 can also be a projector facing away from the exercise bike 120 and configured to play videos and audios, and process programs and algorithms. Wherein the display and computing device 110 provides a user interface, so that a user can operate content displayed on the display and computing device 110 by voice, touch, gesture, etc. The user operation may include selecting music, selecting videos, selecting exercise classes, adjusting volume, etc.

The exercise bike 120 can include a bike frame 121, a handlebar 122 connected to the bike frame 121, a saddle 123 mounted to the bike frame 121, a drive assembly 124 connected to the bike frame 121, wheels 125 connected to the drive assembly 124, and pedals 126 connected to the drive assembly 124. During exercise, the user can hold the handlebar 122, sit on the saddle 123, and step on the pedals 126 with both feet, to drive the wheels to rotate via the drive assembly 124. The exercise bike 120 is provided with multiple bike sensor devices 150. FIG. 1 only schematically illustrates a position of the bike sensor devices 150. In other embodiments, the bike sensor devices 150 can be provided on any one or more of the pedals 126, the drive assembly 124, and the wheels 125, to track and collect the cadence, resistance, etc. Therefore, the tracked and collected data can be user performance data. Furthermore, the user performance data can further include heart rate. For example, the bike sensor devices 150 can further include a sensor on the handlebar 122 for sensing heart rate. In some alternative embodiments, an intelligent wearable apparatus such as an intelligent bracelet can be used for sensing the heart rate of the user. In some alternative embodiments, the bike sensor devices 150 can further include a pressure sensor on the bike saddle 123 for sensing whether the user is on or out of the bike saddle 123.

In the embodiment, the control device 140 can be integrated to the display and computing device 110, or the control device 140 can be an individual device independent of the display and computing device 110 and mounted at any position of the bike frame 121. The control device 140 can communicate with the display and computing device 110 using wired or wireless connections.

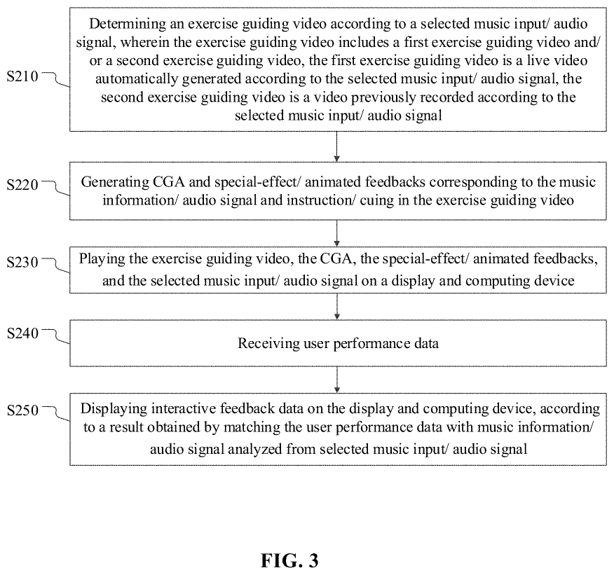

In the embodiment, the control device 140 is configured to: receive an exercise guiding video determined according to a selected music input/audio signal, wherein the exercise guiding video includes a first exercise guiding video and/or a second exercise guiding video, the first exercise guiding video is a live video generated automatically according to the selected music input/audio signal, the second exercise guiding video is a video previously recorded according to the selected music input/audio signal; receive CGA and special-effect/animated feedbacks; control the display and computing device to display the exercise guiding video, the CGA, the special-effect/animated feedbacks and the selected music input/audio signal; receive the user performance data from the bike sensor devices; receive interactive feedback data generated or updated according to a result obtained by matching the user performance data with music information/audio signal analyzed from selected music input/audio signal; control the display and computing device to display the interactive feedback data. The details of the above steps will be further described by combining FIGS. 3-11 in the following.

In the embodiment, the control device 140 can receive the live or previously recorded exercise guiding video from a remote exercise server. The server is configured to provide the exercise guiding video, calculate the interactive feedback data, and match other data, etc. Therefore, the hardware requirement of the control device of the exercise equipment can be lowered down by applying the complex data and algorithm processing to the server, so that the hardware of the exercise equipment can be simplified. In some alternative embodiments, the control device of the exercise equipment can execute a part of the data processing and calculation, to avoid data delay caused by communication problems. The server can be in the form of a server cluster or a distributed server.

In the embodiment, during exercise, the user can select the exercise guiding video or receive the exercise guiding video recommended by the server. The music input/audio signal, the exercise guiding video, the variable CGA, and special-effect/animated feedbacks are overlaid and integrated when displayed on the display and computing device 110. The user can see the guidance in the exercise guiding video, hear the music input/audio signal, and exercise on the excise bike. The bike sensor devices 150 of the exercise bike 120 provide the user performance data to the control device 140 and/or the server. The control device 140 and/or the server can provide the interactive feedback data to the display and computing device 110 according to the matching and analyzing result of the user performance data and the music input/audio signal, so that the display and computing device 110 can show the interactive feedback data to the user.

Therefore, in the present disclosure, on the one hand, individualized service is provided to the user by providing multi-layer video including a variable CGA, special-effect/animated feedbacks, and the interactive feedback data, so that the user can experience an immersive reality extended reality during exercise. On the other hand, by playing the music input/audio signal, and generating or previously recording the exercise guiding video according to the music input/audio signal, the exercise movements are tightly combined with the music information/audio signal of the music input/audio signal to increase entertainment benefit during exercise, so that the user is easier to develop an exercise habit. Furthermore, compared to matching and analyzing the exercise movements to the movements in the exercise guiding video, f matching and analyzing the user performance data to the music information/audio signal of the music input/audio signal has a faster data processing speed and a faster feedback speed.

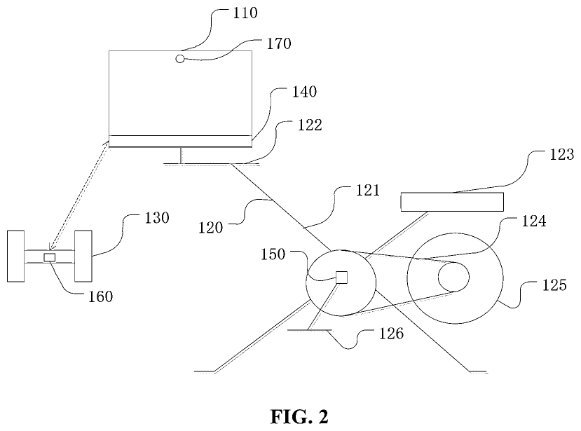

FIG. 2 is a schematic diagram of an exercise equipment according to another embodiment of the present disclosure. As shown in FIG. 2, the exercise equipment includes a first exercise device 120, a second exercise device 130, a display and computing device 100, and a control device 140.

As shown in FIG. 2, the first exercise device 120 is an exercise bike. In some alternative embodiments, the first exercise device 120 can also be an elliptical machine, a treadmill, a rowing machine, or other kinds of exercise devices. The first exercise device 120 is provided with first sensor devices, which are the bike sensor devices 150 in the embodiment. The bike sensor devices 150 can be provided on any one or more of the pedals 126, the drive assembly 124, and the wheels 125, to track and collect the cadence, resistance, etc., during exercise. Therefore, the tracked and collected data can be first user performance data. Furthermore, the first user performance data can further include heart rate and/or whether the user is on or out of the bike saddle 123.

In the embodiment, the second exercise device 130 can be a dumbbell. In some alternative embodiments, the second exercise device 130 can also be a jump rope, a hula hoop, a yoga fitness ring, or other kinds of exercise accessories. The second exercise device 130 is provided with second sensor devices 160 (also called accessory sensor devices). The second sensor devices 160 are configured to track and collect one or more of angular rates, linear velocity, position and heart rate to generate a second user performance data. For example, the second sensor devices 160 can include a gyroscope, a heart rate sensor, etc.

The display and computing device 110 can be a display screen facing the first exercise device 120 and configured to play videos and audios, and process programs and algorithms. In some alternative embodiments, the display and computing device 110 can also be a projector facing away from the first exercise 120 and configured to play videos and audios, and process programs and algorithms. Wherein the display and computing device 110 provides a user interface, so that a user can operate content displayed on the display and computing device 110 in the way of voice control, touch control, gesture control, etc. The user operation can include selecting music, selecting videos, selecting exercise classes, adjusting volume, etc. In some embodiments, the first exercise device 120 is larger than the second exercise device 130. Therefore, the display and computing device 110 can be mounted on the first exercise device 120. In some alternative embodiments, the display and computing device 110 can be mounted to other structures.

In the embodiment, by providing the first exercise device 120 and the second exercise device 130, two exercise modes can be provided: a first exercise mode using the first exercise device 120, and a second exercise mode using the second exercise device 130. In the embodiment, the exercise mode selected by the user can be determined according to a rotation angle of the display and computing device 110. When the display and computing device 110 faces the first exercise device 120, the first exercise mode is selected. When the display and computing device 120 is rotated to face a side of the first exercise device 120 or face away from the first exercise device 120 (face a free space), the second exercise mode is selected. Under different exercise modes, the exercise guiding video provided to the user includes exercise guiding movements corresponding to the currently used exercise device, different user performance data is received from different sensor devices, the matching and analyzing between the user performance data and the related characteristics are executed by different algorithms (for example, the user performance data received from the bike sensor devices 150 can only be matched and analyzed to the music information/audio signal of the music input/audio signal, the user performance data received from the accessory sensor devices 160 can be matched and analyzed to the music information/audio signal of the music input/audio signal and the movement characteristics in the exercise guiding video), and same or different interactive feedback data can be displayed according to different matching and analyzing results of the user performance data.

In the embodiment, the control device 140 is configured to: receive an exercise guiding video determined according to a selected music input/audio signal, wherein the exercise guiding video includes a first exercise guiding video and/or a second exercise guiding video, the first exercise guiding video is a live video generated automatically according to the selected music input/audio signal, the second exercise guiding video is a video previously recorded according to the selected music input/audio signal; receive CGA and special-effect/animated feedbacks; control the display and computing device to display the exercise guiding video, the CGA, the special-effect/animated feedbacks and the selected music input/audio signal; determine whether a first exercise mode or a second exercise mode is selected, according to a rotation angle of the display and computing device; if the first exercise mode is selected: receive the first user performance data from the first sensor devices; receive first interactive feedback data generated or updated according to a matching and analyzing result between the first user performance data and music information/audio signal of the selected music input/audio signal; control the display and computing device to display the first interactive feedback data; if the exercise mode is the second exercise mode: receive the second user performance data from the first sensor devices; receive second interactive feedback data generated or updated according to a matching and analyzing result between the second user performance data and music information/audio signal of the selected music input/audio signal; control the display and computing device to display the second interactive feedback data. The details of the above steps will be further described by combining FIGS. 3-11 in the following.

In the embodiment, when the first exercise mode is selected by the user, the display and computing device 110 faces the first exercise device 120. The user can select the exercise guiding video or receive the exercise guiding video recommended by the server. The exercise guiding video includes movements using the first exercise equipment 120. The music input/audio signal, the exercise guiding video, and the variable CGA and special-effect/animated feedbacks are overlaid and integrated when played on the display and computing device 110. The user can see the guidance in the exercise guiding video, hear the music input/audio signal, and exercise on the first exercise device 120. The first sensor devices 150 of the first exercise device 120 provide the first user performance data to the control device 140 and/or the server. The control device 140 and/or the server provides the first interactive feedback data to the display and computing device 110 according to the matching and analyzing result of the first user performance data and the music input/audio signal, to display the first interactive feedback data on the display and computing device 110. The first interactive feedback data can include whether the first user performance data matches with the music information/audio signal analyzed from the music input/audio signal, whether combo-strike is achieved (determined according to the matching result of the user performance data with the music information/audio signal analyzed from the music input/audio signal), error position/track (and corrected movements) when combo-strike is missed, a number of combo-strikes, a performance level, a performance score, etc.

When the second exercise mode is selected, the display and computing device 110 is rotated to face a side of the first exercise device 120 or face away from the first exercise device 120. The user can select the exercise guiding video or receive the exercise guiding video recommended by the server. The exercise guiding video includes movements using the second exercise equipment 130. The music input/audio signal, the exercise guiding video, and the variable CGA and special-effect/animated feedbacks are overlaid and integrated when played on the display and computing device 110. The user can see the guidance in the exercise guiding video, hear the music input/audio signal and exercise using the second exercise device 130. The second sensor devices 160 of the second exercise device 130 provide the second user performance data to the control device 140 and/or the server. The control device 140 and/or the server provides the second interactive feedback data to the display and computing device 110 according to the matching and analyzing result of the first user performance data to the music input/audio signal (and/or to the movement data in the exercise guiding video), to display the second interactive feedback data on the display and computing device 110. The second interactive feedback data can include whether the second user performance data matches with the music information/audio signal analyzed from the music input/audio signal (and/or to the movement data in the exercise guiding video), whether combo-strike is achieved (determined according to the matching result of the user performance data with the music information/audio signal analyzed from the music input/audio signal), error position/track (and corrected movements) when combo-strike is missed, a number of combo-strikes, a performance level, a performance score, etc.

In the embodiment, the exercise equipment can further include a video capturing device 170. The video capturing device 170 can be mounted on the display and computing device 110 or other structures. The video capturing device 170 is configured to capture user video stream, so that the user movements can be identified from the captured video. The video capturing device 170 can be an accessory to the first exercise device 120 and the second exercise device 130 to supplement the user performance data. The video capturing device 170 can also be used independently. For example, in an embodiment only using the video capturing device 170, the user can also exercise without using the first exercise device 120 and the second exercise device 130. The control device 140 and/or the server matches the identified user performance data to the music input/audio signal (and/or to the movement data in the exercise guiding video), and generates the interactive feedback data.

Therefore, various exercise modes can be provided by using the first exercise device 120 as a main exercise device, and using at least one exercise accessory as a second exercise device 130. There is no need to provide an independent display and computing device for the second exercise device 130, thereby reducing the hardware cost.

FIG. 3 is a flow chart of an exercise method according to an embodiment of the present disclosure. As shown in FIG. 3, the exercise method includes the following steps S210-S250.

S210: determining an exercise guiding video according to a selected music input/audio signal, wherein the exercise guiding video includes a first exercise guiding video and/or a second exercise guiding video, the first exercise guiding video is a live video automatically generated according to the selected music input/audio signal, the second exercise guiding video is a video previously recorded according to the selected music input/audio signal.

In the embodiment, the music input/audio signal is selected according to a user selection. For example, the user can select a music file in a provided music library as the selected music input/audio signal. For another example, the user can upload a local music file as the selected music input/audio signal. For another example, the user can upload a hyperlink of a third-party music file, from which the server can obtain the music input/audio signal and related information. In another embodiment, the music input/audio signal can be streaming media data.

In the embodiment, the music information/audio signal is stored in the music library with a mapping relationship to the music files in the music library. The local music file uploaded by the user can be analyzed by the server/control device to extract the music information/audio signal thereof. The music information/audio signal of the selected music input/audio signal includes music attributes/features and a timeseries/sequence with signals of rhythmic events/features. The timeseries/sequence with signals of rhythmic events/features can include a plurality of segments with signals of rhythmic events/features. The timeseries/sequence with signals of rhythmic events/features can further include bpm (beats per minute). Each segment with signals of rhythmic events/features may further include a timing and location of each beat in the segment with signals of rhythmic events/features of the music input/audio signal and duration of each segment with signals of rhythmic events/features. In some embodiments, each segment with signals of rhythmic events/features can include eight beats. In some alternative embodiments, a number of beats per minute in each segment with signals of rhythmic events/features can be different. The timeseries/sequence with signals of rhythmic events/features may further include a downbeat time series including a timing and location of each downbeat in the music input/audio signal. The music attributes/features include a variety of measurements or quantification of music energy, the music attributes/features further include one or more of music duration, music segments, lyrics, genre, and artist. In the embodiment, the music input/audio signal can be separated into a plurality of music segments according to wording, sentences or segments of the lyrics, the separating information is the information of the music segments. A variety of measurements or quantification of music energy can be varying measurements or quantification of audio intensity between different segments with signals of rhythmic events/features or between different music segments. In some alternative embodiments, the music attributes/features can further include other kinds of characteristics of the music input/audio signal.

In another embodiment, the music input/audio signal is selected by matching and analyzing the music information/audio signal of the music input/audio signal to a persona and user behavior pattern. The persona and user behavior pattern can be obtained by learning from basic data and/or exercise class data of the user. The basic data of the user can include height, age, gender, weight, etc., of the user. The exercise class data of the user may include a class level, movement preference, aesthetic style preference, etc. The movement preference can be obtained by learning from a number of each movement performed by the user, completion status of each movement, and/or other movement data. The aesthetic style preference of the user can be obtained by learning from a number of using each CGA, a number of using each special effect, feedback data after playing the CGA and the special-effect/animated feedbacks in the exercise class data. Furthermore, a matching and analyzing model can be used to obtain a matching and analyzing relationship between the music information/audio signal of the music input/audio signal and the persona and user behavior pattern. In other embodiments, the matching and analyzing can be realized in other ways. For example, a plurality of preferred music files can be obtained as the persona and user behavior pattern from a music playlist of the user in music applications, a number of playing each music file, or other information. Then the music file is selected by matching and analyzing the plurality of preferred music files to the music files in the music library.

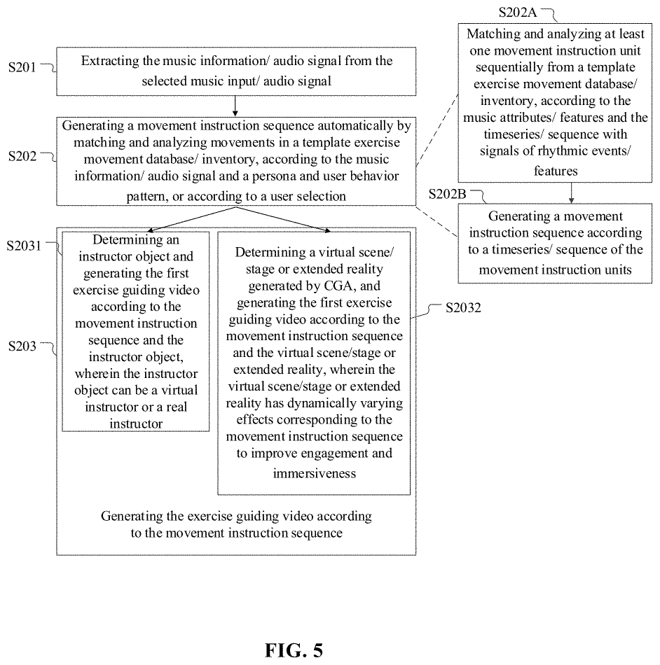

The process of generating and previously recording the exercise guiding video will be described in detail by combining FIGS. 5-7 in the following.

S220: generating CGA and special-effect/animated feedbacks corresponding to the music information/audio signal and instruction/cuing in the exercise guiding video.

In the embodiment, the CGA is used for a background of the exercise guiding video. The CGA can be a static image or a dynamic animation. The CGA can represent a virtual scene/stage or extended reality. For example, the extended reality can be a sea scene, a forest scene, a city scene, or a stage, etc. The virtual scene can be a sea scene, a forest scene, a city scene, or a stage, etc., built of a plurality of elements. In other embodiments, the CGA can also be a background having solid color background or alphabet-inspired background.

In the embodiment, the special-effect/animated feedbacks can be virtual light effects overlaid and integrated on the CGA. The special-effect/animated feedbacks can also be special processing effects to elements in the CGA (for example, image scaling, making the element move/feedback in synchronization with the beats/rhythm, etc.).

In some embodiments, the CGA and the special-effect/animated feedbacks can be matched according to the persona and user behavior pattern. For example, the CGA and the special-effect/animated feedbacks are matched and analyzed to the user's aesthetic style preference in the persona and user behavior pattern. In some other embodiments, the CGA and the special-effect/animated feedbacks are matched according to the music information/audio signal. For example, the CGA and the special-effect/animated feedbacks are matched and analyzed to the music segments, lyrics, genre. In an embodiment, the CGA and the special-effect/animated feedbacks can be labeled, and a model including mapping relations between the music information/audio signal and the labels is previously built. Then the matching and analyzing between the CGA and the special-effect/animated feedbacks and the music information/audio signal can be realized using the model. In another embodiment, the CGA and the special-effect/animated feedbacks can be matched and analyzed to the persona and user behavior pattern and the music information/audio signal. In the embodiment, a first score is obtained by matching and analyzing the CGA and the special-effect/animated feedbacks to the persona and user behavior pattern, and a second score is obtained by matching and analyzing the CGA and the special-effect/animated feedbacks to the music information/audio signal. A total score is obtained by weighted summation of the first score and the second score, and the CGA and the special-effect/animated feedbacks are selected according to the total score.

S230: playing the exercise guiding video, the CGA, the special-effect/animated feedbacks, and the selected music input/audio signal on a display and computing device.

In the embodiment, the step of playing the exercise guiding video, the CGA, the special-effect/animated feedback, and the selected music input/audio signal on a display and computing device further includes synthesizing the exercise guiding video, the CGA, the special-effect/animated feedbacks, and the selected music input/audio signal. Therefore the display and computing device can play an integrated video and audio file.

S240: receiving user performance data.

In the embodiment, the user performance data can be received from different sensor devices of different exercise devices when different exercise devices are used for exercise. For example, when the exercise bike is used for exercise, the user performance data can be received from the bike sensor devices of the exercise bike, and the user performance data can include cadence, resistance, whether the user is on or out of the bike saddle, and heart rate, etc. tracked and collected by the bike sensor devices. When the exercise accessory is used for exercise, the user performance data can be received from the accessory sensor devices of the exercise accessory, and the user performance data can include angular rates, linear velocity, position and heart rate, etc. tracked and collected by the accessory sensor devices. When the user exercises without any exercise device, the user video stream can be received from the video capturing device mounted on the display and computing device, and the user performance data can be identified from the user video stream. The user performance data can include angular rates, linear velocity and position etc., of body parts identified from the user video stream. Identifying the movements of the user from the video stream can be realized by identifying the skeleton points, skeleton feature vectors, angles between the skeleton feature vectors, etc. In different embodiments, one of the above exercise modes can be used independently, or a combination of two or more of the above exercise modes can be used.

S250: displaying interactive feedback data on the display and computing device, according to a result obtained by matching the user performance data with music information/audio signal analyzed from selected music input/audio signal.

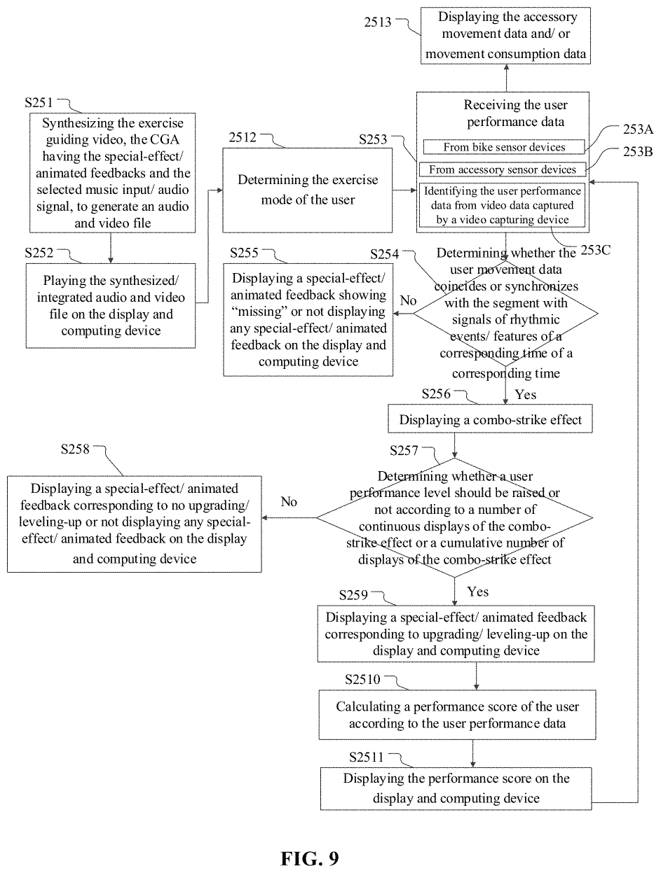

In the embodiment, the interactive feedback data provided can include whether the user movements match to the beat or other audio signals, whether combo-strike is achieved (determined according to the matching result of the user movements with the beat or other audio signals), a number of combo-strikes, a user performance level, a user performance score, user exercise data, etc. The interactive feedback data will be described in detail by combining FIGS. 9-11.

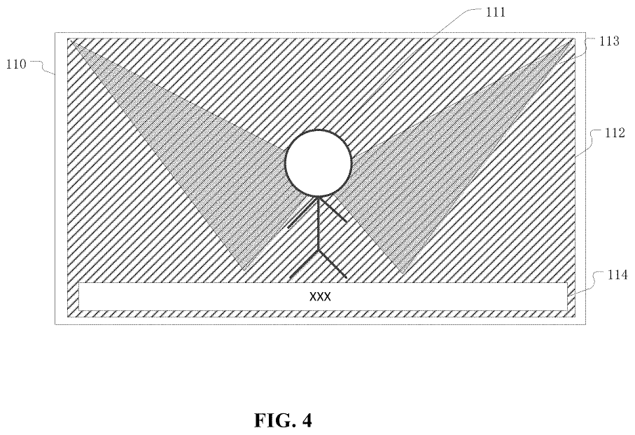

FIG. 4 is a schematic view of a display interface of a display and computing device according to an embodiment of the present disclosure. As shown in FIG. 4, the interface displayed by the display and computing device 110 includes CGA 112, special-effect/animated feedbacks 113, exercise guiding video 111 including an instructor object, and an interactive feedback area 114. FIG. 4 only schematically illustrates a kind of interface provided in the present disclosure. In other embodiments, the interface can be different from that shown in FIG. 4

In the exercise method of the present disclosure, live/streamed videos with multiple layers of visual effects for guiding the user exercise can be provided to the user by playing the exercise guiding video, the CGA, the special-effect/animated feedbacks, and the interactive feedback data in an integrated/multi-layered way. By generating the exercise guiding video according to the music input/audio signal, and generating the interactive feedback data according to the matching and analyzing result between the music file and the user performance data, the exercise process of the user can be guided by the music input/audio signal, the entertainment benefit and the interactive experience during the user exercise are improved.

FIG. 5 is a flow chart of generating a first exercise guiding video according to an embodiment of the present disclosure. As shown in FIG. 5, the first exercise guiding video is generated by the following steps.

S201: extracting the music information/audio signal from the selected music input/audio signal.

In the embodiment, the music information/audio signal can include a timeseries/sequence with signals of rhythmic events/features. In some embodiments, the timeseries/sequence with signals of rhythmic events/features can be extracted by a trained model. In another embodiment, the timeseries/sequence with signals of rhythmic events/features can be extracted by processing the audio data of the selected music input/audio signal. In the embodiment, the timeseries/sequence with signals of rhythmic events/features can be obtained by: identifying the beats from the selected music input/audio signal, obtaining the timing and location of each beat in the selected music input/audio signal, separating the beats of the selected music input/audio signal into a plurality of segments with signals of rhythmic events/features, and sequencing the plurality of segments with signals of rhythmic events/features by time to get the timeseries/sequence with signals of rhythmic events/features. Furthermore, bpm (beats per minute) can also be calculated according to the number of beats per minute identified in the selected music input/audio signal.

In the embodiment, the music information/audio signal of the selected music input/audio signal can include music attributes/features. The music attributes/features can include music duration, lyrics, genre, and artist, etc. The music duration, lyrics, genre, and artist can be stored with a mapping relationship to the selected music input/audio signal; therefore, the music information/audio signal can be obtained directly according to the selected music input/audio signal. The music attributes/features can include music segments, wherein the separating information is the information of the music segments. The variety of measurements or quantification of music energy can be varying measurements or quantification of audio intensity between different segments with signals of rhythmic events/features or between different music segments. Therefore, a variety of measurements or quantification of music energy can be obtained by processing the audio signal of the selected music input/audio signal.

S202: generating a movement instruction sequence automatically by matching and analyzing movements in a template exercise movement database/inventory, according to the music information/audio signal and a persona and user behavior pattern, or according to a user selection.

In the embodiment, the template exercise movement database/inventory includes a plurality of movement instruction units. The movement data can be stored in the template exercise movement database/inventory according to the movement instruction units. The movement data can include a two- or three-dimensional movement model/mechanism. For example, in a movement model/mechanism, the skeleton points, skeleton feature vectors, angles between the skeleton feature vectors, etc., are stored as objects of the movement instruction units. Position, moving track, moving speed of the objects of the movement instruction units are stored as the movement attributes/features of the objects of the movement instruction units.

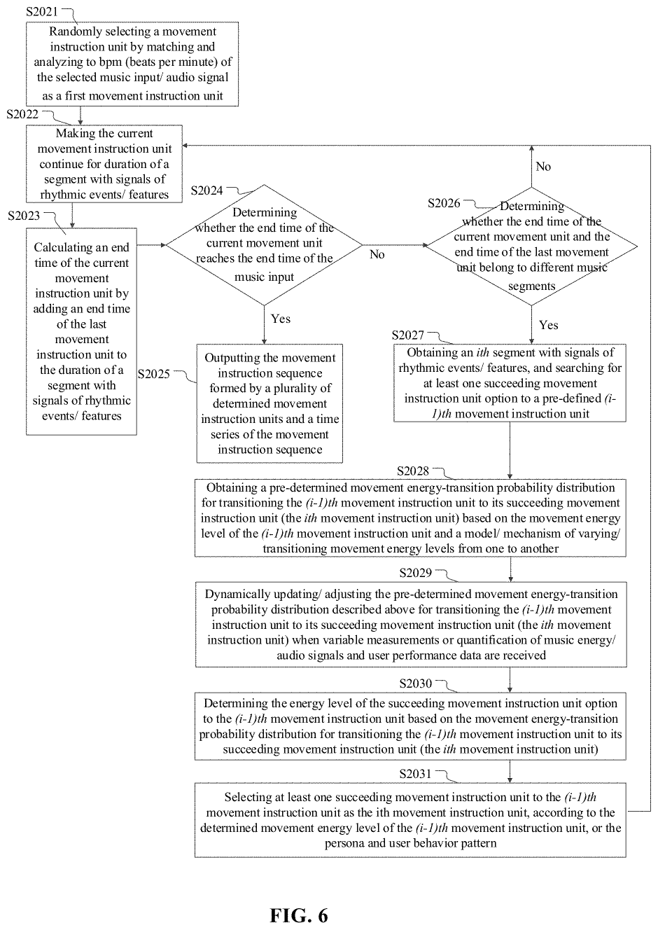

In the embodiment, step S202 can further include: step S202A: matching and analyzing at least one movement instruction unit sequentially from a template exercise movement database/inventory, according to the music attributes (such as beats per minutes, musical structure, music energy, rhythmic segmentation, etc.)/features and the timeseries/sequence with signals of rhythmic events/features, wherein the template exercise movement database/inventory includes a plurality of movement instruction units; and step S202B: generating a movement instruction sequence according to a timeseries/sequence of the movement instruction units. In the embodiment, the details of step S202 will be described in the following by combining FIG. 6.

S203: generating the exercise guiding video according to the movement instruction sequence.

In the embodiment, the exercise guiding video generated in S203 is the first exercise guiding video. Step S203 can include step S2031: determining an instructor object and generating the first exercise guiding video according to the movement instruction sequence and the instructor object, wherein the instructor object can be a virtual instructor or a real instructor. In the embodiment, the virtual instructor can be a virtual instructor figure or an animated figure. The virtual instructor can be stored together with mapping relationships to figure data configured for building movements. The figure data can include virtual figure display data (for example, muscles, skins, etc.) based on the skeleton points, skeleton feature vectors, angles between the skeleton feature vectors, etc. Therefore, the virtual figure display data can be generated by matching and analyzing the data of each movement instruction unit in the movement instruction sequence to the stored virtual figure display data and synthesizing the data of each movement instruction unit with the matched virtual figure display data. In the embodiments, the real instructor can record content videos of the movement instruction units according to the template exercise movement database/inventory. Therefore, the first exercise guiding video can be generated by matching and analyzing the movement instruction sequence to the content video of each movement instruction unit previously recorded by the selected real instructor.

Furthermore, the instructor object can be determined according to a user selection. In other embodiments, the instructor object can also be determined according to the music information/audio signal of the music input/audio signal and/or the persona and user behavior pattern. For example, user-preferred instructor objects can be determined according to historical exercise class data of the user. For another example, a user-preferred label of the instructor object can be determined according to the historical exercise class data of the user, and the instructor object can be determined by matching and analyzing the user-preferred label of the instructor object to the stored labels of the instructor objects. For another embodiment, a model can be used to learn the relationships between the music information/audio signal of the music input/audio signals and the instructor objects, to realize the matching and analyzing between the music information/audio signal of the music input/audio signals and the instructor objects by the model. Wherein the music information/audio signal of the music input/audio signals can include only a part of the music attributes/features, for example, the genre, artist, lyrics, etc., to increase the efficiency of training and using the model. For another example, the instructor object can be determined by matching and analyzing the instructor objects to the music information/audio signal and the persona and user behavior pattern.

Step S203 can further include step 2032: determining a virtual scene/stage or extended reality generated by CGA, and generating the first exercise guiding video according to the movement instruction sequence and the virtual scene/stage or extended reality, wherein the virtual scene/stage or extended reality has dynamically varying effects corresponding to the movement instruction sequence to improve engagement and immersiveness. In the embodiment, the virtual scene/stage or extended reality generated by CGA uses a scene or stage to show the movement instruction sequence, which is different from the aforementioned front layer using a form of an instructor object showing the movement instruction sequence. The virtual scene/stage or extended reality can be in the form of characters, graphics, etc., and the virtual scene/stage or extended reality has dynamically varying effects corresponding to the movement instruction sequence to improve engagement and immersiveness to show the movement instruction sequence.

Furthermore, the virtual scene/stage or extended reality generated by CGA can be selected by the user. In other embodiments, the virtual scene/stage or extended reality generated by CGA can also be determined according to the music information/audio signal of the music input/audio signal and/or the persona and user behavior pattern. For example, user-preferred virtual scene/stage or extended reality generated by CGA can be determined according to the historical exercise class data of the user. For another example, a user-preferred label of the virtual scene/stage or extended reality generated by CGA can be determined according to the historical exercise class data of the user, and the virtual scene/stage or extended reality generated by CGA can be determined by matching and analyzing the user-preferred label of the virtual scene/stage or extended reality generated by CGA to the stored labels of the virtual scenes/stages or extended reality generated by CGA. For another embodiment, a model can be used to learn the mapping relationships between the music information/audio signal of the music input/audio signals and the virtual scene/stage or extended reality generated by CGA, to realize the matching and analyzing between the music information/audio signal of the music input/audio signals and the virtual scene/stage or extended reality by the model. Wherein the music information/audio signal of the music input/audio signals can include only a part of the music attributes/features, for example, the genre, artist, lyrics, etc., to increase the efficiency of training and using the model. For another example, the virtual scene/stage or extended reality generated by CGA can be determined by matching and analyzing the virtual scenes/stages or extended reality generated by CGA to the music information/audio signal and the persona and user behavior pattern.

In the embodiment, while generating the first exercise guiding video according to the movement instruction sequence, a preset rule can be used to adjust the video to make the transition between the movement instruction units smoother.

FIG. 6 is a flow chart of generating the movement instruction sequence. As shown in FIG. 6, the movement instruction sequence is generated by the following steps:

S2021: randomly selecting a movement instruction unit by matching and analyzing to bpm (beats per minute) of the selected music input/audio signal as a first movement instruction unit.

In the embodiment, each movement instruction unit can be stored with a mapping relationship to the corresponding bpm (beats per minute).

S2022: making the current movement instruction unit continue for duration of a segment with signals of rhythmic events/features.

For example, a movement duration of the current movement instruction unit is two beats, the duration of a segment with signals of rhythmic events/features is eight beats. So, the current movement instruction unit is repeated four times to continue for the duration of a segment with signals of rhythmic events/features.

S2023: calculating an end time of the current movement instruction unit by adding an end time of the last movement instruction unit to the duration of a segment with signals of rhythmic events/features.

S2024: determining whether the end time of the current movement instruction unit reaches the end time of the music input/audio signal.

If the end time of the current movement instruction unit reaches the end time of the music input/audio signal, the matching and analyzing of all the segments with signals of rhythmic events/features of the selected music input/audio signal have been completed, then step S2025 is executed, outputting the movement instruction sequence formed by a plurality of determined movement instruction units and a time series of the movement instruction sequence.

If the end time of the current movement instruction unit hasn't reached the total duration of the music input/audio signal, step S2026 is executed, determining whether the end time of the current movement instruction unit and the end time of the last movement instruction unit belong to different music segments.

If the end time of the current movement instruction unit and the end time of the last movement instruction unit belong to different music segments, step S2022 is executed again.

In the embodiment, step S2026 can be omitted according to different exercise requirements and exercise movements. For example, the number of exercise movements using the exercise bike is less than other exercise modes, each movement instruction unit is made to continue for the duration of each music segment. When the music segment changes, steps S2027 to S2031 are executed to determine the subsequent movement instruction unit again. For another example, the number of exercise movements using the exercise accessory is more than other exercise modes, step S2026 can be omitted, to make the movement instruction unit only continue for the duration of a segment with signals of rhythmic events/features.

After step 2026, if the end time of the current movement instruction unit and the end time of the last movement instruction unit belong to a same music segment, then step S2027 is executed, obtaining an ith segment with signals of rhythmic events/features, and searching for at least one succeeding movement instruction unit option to a pre-defined (i−1)th movement instruction unit.

In the embodiment, i is an integer ranging from 2 to N, and N is a number of the segments with signals of rhythmic events/features in the timeseries/sequence with signals of rhythmic events/features. Wherein an initial value of i is 2, and every time the following step S2031 is executed, i=i+1.

In an embodiment, transition problems exist between different movement instruction units. Therefore, each movement instruction unit is related to a plurality of succeeding movement instruction unit options.

S2028: obtaining a pre-determined movement energy-transition probability distribution for transitioning the (i−1)th movement instruction unit to its succeeding movement instruction unit (the ith movement instruction unit) based on the movement energy level of the (i−1)th movement instruction unit and a model/mechanism of varying/transitioning movement energy levels from one to another.

In the embodiment, the movement energy level of each movement instruction unit is a preset movement intensity. A high-intensity movement instruction unit succeeding to another high-intensity movement instruction unit may cause excessive exercise intensity for the user, and may cause sports injuries to the user. A low-intensity movement instruction unit succeeding to another low-intensity movement instruction unit may cause insufficient movement intensity for the user, and expected exercise effects could not be achieved. In the embodiment, the model/mechanism of varying/transitioning movement energy levels from one to another can be obtained by learning the energy level varying measurements or quantification between the movement instruction units from historical exercise data. For example, the historical exercise data can be historical exercise class data. Sample data can be obtained by separating the movement instruction units in the historical exercise class data and determining the energy levels of the movement instruction units in the historical exercise class data. Then the model/mechanism of varying/transitioning movement energy levels from one to another can be trained using the sample data. The model/mechanism of varying/transitioning movement energy levels from one to another can provide a basic and general method of varying/transitioning movement energy levels from one to another. In step S2028, the movement energy level of the (i−1)th movement instruction unit can be input to the model/mechanism of varying/transitioning movement energy levels from one to another to obtain the pre-determined movement energy-transition probability distribution for transitioning the (i−1)th movement instruction unit to its succeeding movement instruction unit (the ith movement instruction unit). For example, the probability distribution of the movement energy level of transitioning the (i−1)th movement instruction unit to a first movement instruction unit option is a %, the probability distribution of the movement energy level of transitioning the (i−1)th movement instruction unit to a second movement instruction unit option is b %, and the probability distribution of the movement energy level of transitioning the (i−1)th movement instruction unit to a third movement instruction unit option is c %.

S2029: dynamically updating/adjusting the pre-determined movement energy-transition probability distribution described above for transitioning the (i−1)th movement instruction unit to its succeeding movement instruction unit (the ith movement instruction unit) when variable measurements or quantification of music energy/audio signals and user performance data are received.

In the embodiment, by step S2029, the pre-determined movement energy-transition probability distribution described above for transitioning the (i−1)th movement instruction unit to its succeeding movement instruction unit (the ith movement instruction unit) are further updated/adjusted according to a variety of measurements or quantification of music energy and the user performance data, based on the basic and general movement energy-transition probability distribution provided by the model/mechanism of varying/transitioning movement energy levels from one to another.

In the embodiment, the user performance data can include user live performance data or user performance data in a recent time period. Therefore, the user performance data can be used for determining whether the user can adapt to the model/mechanism of varying/transitioning movement energy levels from one to another. If yes, there is no need to adjust the obtained pre-determined movement energy-transition probability distribution. If no, it is determined that whether the user can complete the movement easily (for example, the user has a low heart rate during exercise) or the user feels hard to complete the movement (for example, the user has a high heart rate during exercise). If the user can complete the movement easily, probabilities of high energy levels can be raised and probabilities of low energy levels can be decreased in the movement energy-transition probability distribution. If the user feels hard to complete the movement, the probabilities of high energy levels can be decreased and the probabilities of low energy levels can be raised in the movement energy-transition probability distribution.

In the embodiment, a variety of measurements or quantification of music energy can be used for representing the varying measurements or quantification of the audio intensity. In general, when the audio intensity of the music input/audio signal is higher, the energy level of the current movement is higher; when the audio intensity of the music input/audio signal is lower, the energy level of the current movement is lower. Therefore, the music input/audio signal and the movements can be tightly combined. In the embodiment, if an energy level of the current music segment/segment with signals of rhythmic events/features is higher than an energy level of the last music segment/segment with signals of rhythmic events/features, probabilities of energy levels of the succeeding movement instruction unit option to the last movement instruction unit higher than the energy level of the last movement instruction unit can be raised, probabilities of energy levels of the succeeding movement instruction unit option to the last movement instruction unit lower than the energy level of the last movement instruction unit can be decreased. If the energy level of the current music segment/segment with signals of rhythmic events/features is lower than the energy level of the last music segment/segment with signals of rhythmic events/features, the probabilities of energy levels of the succeeding movement instruction unit option to the last movement instruction unit higher than the energy level of the last movement instruction unit can be decreased, probabilities of energy levels of the succeeding movement instruction unit option to the last movement instruction unit lower than the energy level of the last movement instruction unit can be raised. If the energy level of the current music segment/segment with signals of rhythmic events/features is equal to the energy level of the last music segment/segment with signals of rhythmic events/features, there is no need to adjust the pre-determined movement energy-transition probability distribution.

S2030: determining the energy level of the succeeding movement instruction unit option to the (i−1)th movement instruction unit based on the movement energy-transition probability distribution for transitioning the (i−1)th movement instruction unit to its succeeding movement instruction unit (the ith movement instruction unit).

In the embodiment, an energy level having the highest probability can be determined to be the movement energy level of the succeeding movement instruction unit option to the (i−1)th movement instruction unit.

S2031: selecting at least one succeeding movement instruction unit to the (i−1)th movement instruction unit as the ith movement instruction unit, according to the determined movement energy level of the (i−1)th movement instruction unit, or the persona and user behavior pattern.

In some embodiments, a movement instruction unit can be determined as the ith movement instruction unit, by selecting from at least one succeeding movement instruction unit option of the (i−1)th movement instruction unit according to the determined movement energy level. In other embodiments, the movement instruction unit can be selected by the user as the ith movement instruction unit, from at least one succeeding movement instruction unit option of the (i−1)th movement instruction unit according to the determined movement energy level. In other embodiments, the movement instruction unit can be determined as the ith movement instruction unit, by selecting from at least one succeeding movement instruction unit option of the (i−1)th movement instruction unit according to the determined movement energy level and the persona and user behavior pattern. Wherein the persona and user behavior pattern includes the user's preferred movements, which can be stored in the form of a preferred movement set. Therefore, the ith movement instruction unit can be determined by matching and analyzing the preferred movement set with at least one succeeding movement instruction unit.

After step S2031 is executed, step S2022 is executed again.

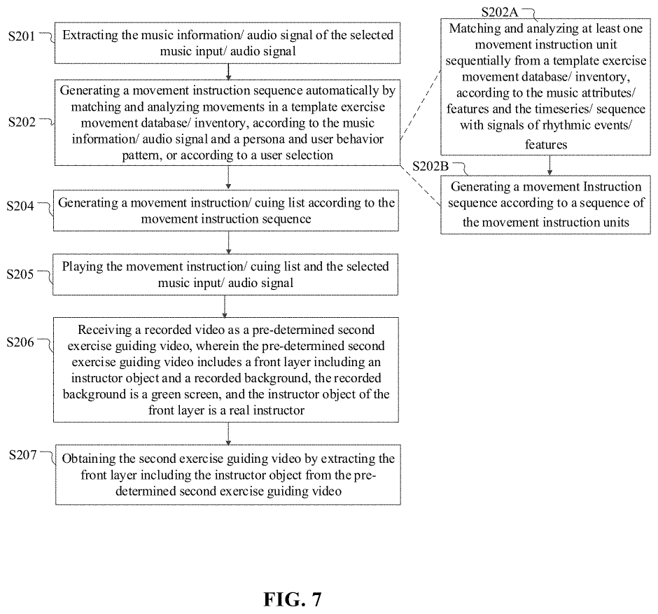

FIG. 7 is a flow chart of generating a second exercise guiding video according to an embodiment of the present disclosure. As shown in FIG. 7, the second exercise guiding video is generated by the following steps.

S201: extracting the music information/audio signal of the selected music input/audio signal.

S202: generating a movement instruction sequence automatically by matching and analyzing movements in a template exercise movement database/inventory, according to the music information/audio signal and a persona and user behavior pattern, or according to a user selection.

In the embodiment, step S202 can further include: step S202A: matching and analyzing at least one movement instruction unit sequentially from a template exercise movement database/inventory, according to the music attributes/features and the timeseries/sequence with signals of rhythmic events/features; and step S202B: generating a movement instruction sequence according to a sequence of the movement instruction units, the details of step S202 will be referred to the aforementioned description by combining FIG. 6.

S204: generating a movement instruction/cuing list according to the movement instruction sequence.

In the embodiment, the movement instruction/cuing list is used to show the movement instruction sequence to be recorded. In some embodiments, the movement instruction/cuing list can be the first exercise guiding video generated by the steps shown in FIG. 5. In other embodiments, the movement instruction/cuing list can show the movement data (stored in the template exercise movement database/inventory) of each movement instruction unit of the movement instruction sequence. In some other embodiments, the movement instruction/cuing list can show a cue in text form.

S205: playing the movement instruction/cuing list and the selected music input/audio signal.

In the embodiment, the movement instruction/cuing list and the selected music input/audio signal are synchronized in a time sequence. Therefore, the movement instruction/cuing list and the selected music input/audio signal synchronized in time sequence/timeseries can be played for the instructor so that the instructor can record a pre-determined second exercise guiding video under the guidance of the movement instruction/cuing list and the selected music input/audio signal. Furthermore, the time sequence of the music cue file can be set ahead of the selected music input/audio signal for a preset time. The instructor has enough time to understand the movement cue after seeing the movement cue video. Therefore, the movements performed by the instructor according to the movement instruction/cuing list can be synchronized with the selected music input/audio signal in the time sequence.

S206: receiving a recorded video as a pre-determined second exercise guiding video, wherein the pre-determined second exercise guiding video includes a front layer including an instructor object and a recorded background, the recorded background is a green screen, and the instructor object of the front layer is a real instructor.

S207: obtaining the second exercise guiding video by extracting the front layer including the instructor object from the pre-determined second exercise guiding video.

In the embodiment, the second exercise guiding video is recorded using a green screen to facilitate the removal of the green screen. Therefore, the green screen can be easily removed from the pre-determined second exercise guiding video to extract the front layer including the instructor object, to generate the second exercise guiding video.

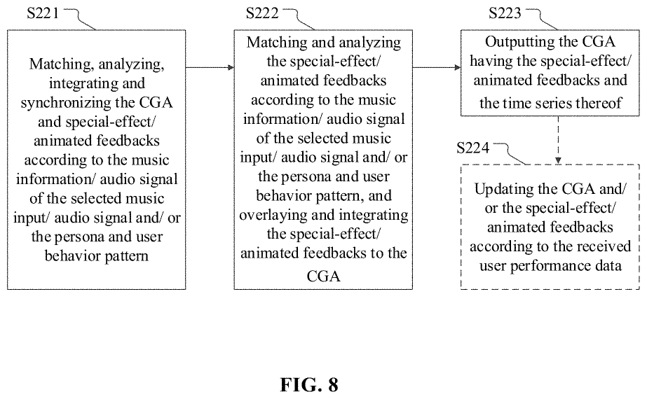

FIG. 8 is a flow chart of generating a CGA including special-effect/animated feedbacks according to an embodiment of the present disclosure. As shown in FIG. 8, the CGA is by the following steps:

S221: matching, analyzing, integrating and synchronizing the CGA and special-effect/animated feedbacks according to the music information/audio signal of the selected music input/audio signal and/or the persona and user behavior pattern.

In the embodiment, the CGA can be selected from a CGA library, according to one or more of the music genres, the aesthetic style preference (preferred CGA style) in the persona and user behavior pattern, the style requirement to the CGA of a class/community marketing activity. In the embodiment, each CGA is stored in the CGA library with a mapping relationship to a style label. Therefore, the CGA can be selected and determined by matching and analyzing the style label.

S222: matching and analyzing the special-effect/animated feedbacks according to the music information/audio signal of the selected music input/audio signal and/or the persona and user behavior pattern, and overlaying and integrating the special-effect/animated feedbacks to the CGA.

For example, the special-effect/animated feedbacks can be light effects, particle effects, etc. In the embodiment, the special-effect/animated feedbacks can be selected from a special-effect/animated library, according to the aesthetic style preference (preferred CGA style) of the user and/or the music genre. Furthermore, the varying of the special-effect/animated feedback can be determined according to the timeseries/sequence with signals of rhythmic events/features of the music input/audio signal (including a beat time series and a downbeat time series), music segments, a variety of measurements or quantification of music energy. For example, the light effects can flash following the beats in the beat time series. The brightness of the light effect can be increased at the timing and location of the downbeat in the downbeat time series. The brightness can vary following the varying measurements or quantification of the music energy. For example, when the music energy of the current music segment/segment with signals of rhythmic events/features is greater, the brightness of the light effect is greater; when the music energy of the current music segment/segment with signals of rhythmic events/features is smaller, the brightness of the light effect is smaller.

Therefore, the determined special-effect/animated feedbacks and the method of changing the special-effect/animated feedbacks can be overlaid and integrated to the CGA.

S223: outputting the CGA having the special-effect/animated feedbacks and the time series thereof.

S224: updating the CGA and/or the special-effect/animated feedbacks according to the received user performance data.

In some embodiments, step S224 can be omitted. Therefore, the CGA and the special-effect/animated feedbacks obtained from step S223 can be output. In other embodiments, step S224 is executed to improve the interactive experience of the user. For example, when the user performance data shows that the current movement intensity is excessive for the user, the CGA and/or the special-effect/animated feedbacks can be adjusted to more smoothing CGA and/or special-effect/animated feedbacks, to help the user to alleviate exercise fatigue. For example, when the user performance data shows that the user is not exerting full effort during current exercise, the CGA and/or the special-effect/animated feedbacks can be adjusted to more striking CGA and/or special-effect/animated feedbacks to urge the user to exercise.

FIG. 9 is a flow chart of providing interactive feedback according to an embodiment of the present disclosure. As shown in FIG. 9, the interactive feedback is provided by the following steps.

S251: synthesizing the exercise guiding video, the CGA having the special-effect/animated feedbacks and the selected music input/audio signal, to generate an audio and video file.

S252: playing the synthesized/integrated audio and video file on the display and computing device.

S2512: determining the exercise mode of the user.

In an embodiment only having one exercise mode, step S2512 can be omitted.

In the embodiment, the exercise modes include an exercise bike mode, an exercise accessory mode, and a computer vision mode.

S253: receiving the user performance data.

In the embodiment, if the user exercise mode is the exercise bike mode, step S253A is executed, receiving the user performance data from bike sensor devices of an exercise bike. If the user exercise mode is the exercise accessory mode, step S253B is executed, receiving the user performance data from accessory sensor devices of an exercise accessory. If the user exercise mode is the computer vision mode, step S253C is executed, receiving video stream of the user movements from a video capturing device; and identifying the user performance data from the video stream.

S254: determining whether the user performance data coincides or synchronizes with the segment with signals of rhythmic events/features of a corresponding time.

If the user performance data doesn't coincide or synchronize with the segment with signals of rhythmic events/features of a corresponding time, step S255 is executed, displaying a special-effect/animated feedback showing “missing” or not displaying any special-effect/animated feedback on the display and computing device.

If the user performance data coincides or synchronizes with the segment with signals of rhythmic events/features of a corresponding time, step S256 is executed, displaying a combo-strike effect.

S257: determining whether a user performance level should be raised or not according to a number of continuous displays of the combo-strike effect or a cumulative number of displays of the combo-strike effect.

If the user performance level shouldn't be raised, step S258 is executed, displaying a special-effect/animated feedback corresponding to no upgrading/leveling-up or not displaying any special-effect/animated feedback on the display and computing device.

If the user performance level should be upgraded, step S259 is executed, displaying a special-effect/animated feedback corresponding to upgrading/leveling-up on the display and computing device.

In the embodiment, steps S257-S259 are executed to inspire the user by displaying the special-effect/animated feedback corresponding to upgrading/leveling-up. The user performance level can represent the current exercise amount/movement intensity. The user performance level can be obtained by calculating a number of continuous displays of the combo-strike effect or a cumulative number of displays of the combo-strike effect. For example, when the number of continuous displays of the combo-strike effect is greater than a preset threshold, the user performance level should be upgraded. For another example, when the cumulative number of displays of the combo-strike effect is greater than a preset threshold, the user performance level should be upgraded/leveled up. When the cumulative number of displays of the combo-strike effect minus the cumulative number of displays of the combo-strike effect before the last time upgrade is greater than a preset threshold, the user performance level should be upgraded. Other varying modes can also be used in other embodiments of the present disclosure. In some embodiments, steps S257-S259 can also be omitted.

S2510: calculating a performance score of the user according to the user performance data.

In the embodiment, in step S2510, a unit score of the current movement instruction unit performed by the user can be firstly calculated, then the performance score of the user can be obtained by accumulating the unit score of the previous movement instruction units.

In an embodiment using the exercise bike, the unit score can be calculated based on the resistance of the user performance data.

In the embodiment, when step S2510 is executed, the current movement instruction unit of the user is matched and analyzed to the music information/audio signal of the music input/audio signal. That is to say, when step S2510 is executed, the current movement instruction unit is completed by the user, and a basic unit score can be obtained. The unit performance score can be calculated based on the basic unit score and the resistance of the user performance data. For example, a weight coefficient is calculated according to the resistance of the user performance data, and the unit score can be obtained by multiplying the weight coefficient and the basic unit score. The weight coefficient is positively related to the resistance of the user performance data. In other embodiments, the performance score can be obtained in other ways.

S2511: displaying the performance score on the display and computing device.

Wherein, after step S253, step S2513 is executed, displaying the accessory movement data and/or movement consumption data. The movement consumption data is obtained by at least calculating based on the accessory movement data. The accessory movement data includes one or more of heart rate, movement duration, movement intensity.

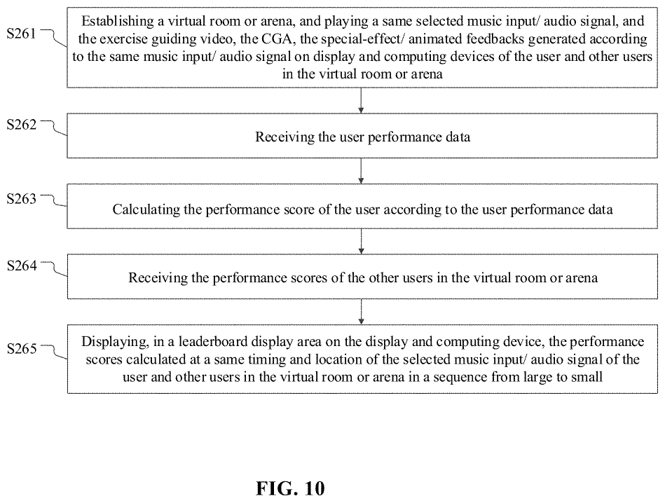

FIG. 10 is a flow chart of displaying a leaderboard display area according to an embodiment of the present disclosure. As shown in FIG. 10, the leaderboard display area is displayed by the following steps.

S261: establishing a virtual room or arena, and playing a same selected music input/audio signal, and the exercise guiding video, the CGA, the special-effect/animated feedbacks generated according to the same music input/audio signal on display and computing devices of the user and other users in the virtual room or arena.

In the embodiment, a user can send, via the exercise device (or a mobile device associated with the exercise device), an invitation of establishing a virtual room or arena to the exercise devices (or mobile devices associated with the exercise devices) of other users. When at least one user receives the invitation and sends feedback data, the communication channel between the users in the virtual room or arena is built.

In an alternative embodiment, in the virtual room or arena, the display and computing devices of the users play the same content. In some embodiments, in the virtual room or arena, the display and computing devices of the user and other users in the virtual room or arena play the same selected music input/audio signal, and the exercise guiding video, the CGA, the special-effect/animated feedbacks generated according to the same music input/audio signal.

S262: receiving the user performance data.

S263: calculating the performance score of the user according to the user performance data.

S264: receiving the performance scores of the other users in the virtual room or arena.

S265: displaying, in a leaderboard display area on the display and computing device, the performance scores calculated at a same timing and location of the selected music input/audio signal of the user and other users in the virtual room or arena in a sequence from large to small. Wherein the displayed performance scores include the performance scores of the other users in the same virtual room or arena with the user at a same timing and location of the selected music input/audio signal.

In the embodiments, the display and computing devices of the other users in a same virtual room or arena play a same selected music input/audio signal at the same time with the display and computing device of the user. The live performance scores of the other users in the same virtual room or arena can be received, so that the displayed performance scores include the performance scores of the other users in the same virtual room or arena with the user at a same timing and location of the selected music input/audio signal.

In another embodiment, the display and computing devices of the other users in the same virtual room or arena don't have to play the same selected music input/audio signal at the same time with the display and computing device of the user. Displaying the performance scores calculated at a same timing and location of the selected music input/audio signal of the user and other users in the virtual room or arena can be realized by receiving the performance scores of the other users calculated at the current timing and location of the selected music input/audio signal played by the user. In other words, the performance scores of the user at various timing and locations of the selected music input/audio signal can be stored. Therefore, other users can receive the scores for display.

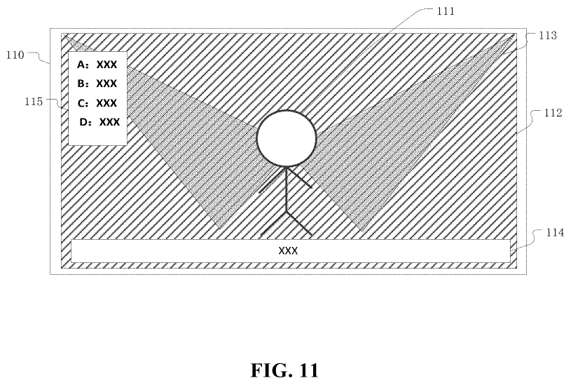

As shown in FIG. 11, the display and computing device 110 includes CGA 112, special-effect/animated feedbacks 113, exercise guiding video 111 including an instructor object, an interactive feedback area 114, and a leaderboard display area 115. The leaderboard display area 115 can show user accounts and/or avatars of the users, and corresponding performance scores. The sequence of the performance scores displayed in the leaderboard display area 115 dynamically varies following the varying of the performance scores. FIG. 11 only schematically illustrates a kind of display interface provided by the present disclosure. In other embodiments, the display interface can be different from that shown in FIG. 11.

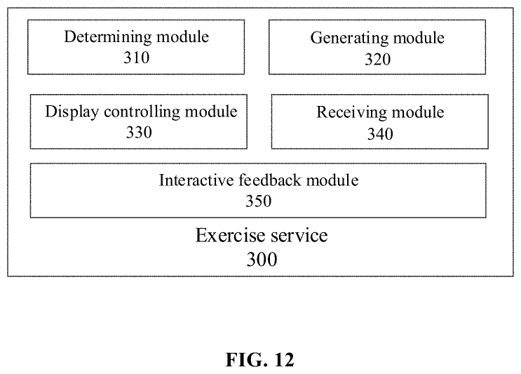

FIG. 12 is a block diagram of an exercise server according to an embodiment of the present disclosure. The server 300 can communicate and interact with the exercise equipment shown in FIG. 1 and FIG. 2, to provide related video and data service. The server 300 includes a determining module 310, a generating module 320, a display controlling module 330, a receiving module 340, and an interactive feedback module 350.

The determining module 310 is configured to determine an exercise guiding video according to a selected music input/audio signal, wherein the exercise guiding video includes a first exercise guiding video and/or a second exercise guiding video, the first exercise guiding video is a live video automatically generated according to the selected music input/audio signal, the second exercise guiding video is a video previously recorded according to the selected music input/audio signal. The generating module 320 is configured to generate CGA (Computer Generated Animation) and special-effect/animated feedbacks corresponding to the music information/audio signal and instruction/cuing in the exercise guiding video. The display controlling module 330 is configured to play the exercise guiding video, the CGA, the special-effect/animated feedbacks, and the selected music input/audio signal on a display and computing device. The receiving module is configured to receive user performance data. The interactive display module 350 is configured to display interactive feedback data on the display and computing device, according to a result obtained by matching the user performance data with music information/audio signal analyzed from selected music input/audio signal.

FIG. 12 only schematically illustrative the exercise server 300 provided by the present disclosure. In other embodiments, the modules in the server 300 can be separated or combined, or other modules can be added to the server 300. The server 300 can be composed of software, hardware, firmware, plug-in components or any combination thereof.

Compared to the existing technology, the present disclosure has the following advantages.

During exercise, live/streamed videos with multiple layers of visual effects for guiding the user exercise can be provided to the user by playing the exercise guiding video, the CGA, the special-effect/animated feedbacks, and the interactive feedback data in an integrated/multi-layered way. By generating the exercise guiding video according to the music input/audio signal, and generating the interactive feedback data according to the matching and analyzing result between the music file and the user performance data, the exercise process of the user can be guided by the music input/audio signal, the entertainment benefit and the interactive experience during the user exercise are improved.

The above is a detailed description of the present disclosure in connection with the specific preferred embodiments, and the specific embodiments of the present disclosure are not limited to the description. Modifications and substitutions can be made without departing from the spirit and scope of the present disclosure.

What is claimed is:

1. An exercise method comprising:
determining an exercise guiding video according to a selected music input/audio signal, wherein the exercise guiding video comprises a first exercise guiding video and/or a second exercise guiding video, the first exercise guiding video is a live video automatically generated according to the selected music input/audio signal, the second exercise guiding video is a video previously recorded according to the selected music input/audio signal;
generating CGA (Computer Generated Animation) and special-effect/animated feedbacks corresponding to the music information/audio signal and instruction/cuing in the exercise guiding video;
playing the exercise guiding video, the CGA, the special-effect/animated feedbacks and the selected music input/audio signal on a display and computing device;
receiving user performance data;
displaying interactive feedback data on the display and computing device, according to a result obtained by matching the user performance data with music information/audio signal analyzed from selected music input/audio signal.

2. The exercise method according to claim 1, wherein, the music input/audio signal is selected according to a user selection; or,
the music input/audio signal is selected by matching and analyzing the music information/audio signal of the music input/audio signal to a persona and user behavior pattern.

3. The exercise method according to claim 1, wherein, the exercise guiding video is generated by:
extracting the music information/audio signal from the selected music input/audio signal;
generating a movement instruction sequence automatically by matching and analyzing movements in a template exercise movement database/inventory, according to the music information/audio signal and a persona and user behavior pattern, or according to a user selection;
generating the exercise guiding video according to the movement instruction sequence.

4. The exercise method according to claim 3, wherein, the music information/audio signal of the selected music input/audio signal comprises music attributes/features and a timeseries/sequence with signals of rhythmic events/features, the movement instruction sequence is generated by:
matching and analyzing at least one movement instruction unit sequentially from a template exercise movement database/inventory, according to the music attributes/features and the timeseries/sequence with signals of rhythmic events/features, wherein the template exercise movement database/inventory includes a plurality of movement instruction units;
generating a movement instruction sequence according to a sequence of the movement instruction units.

5. The exercise method according to claim 4, wherein, the timeseries/sequence with signals of rhythmic events/features comprises a plurality of segments with signals of rhythmic events/features, the music attributes/features comprise a variety of measurements or quantification of music energy, the music attributes/features further comprise one or more of music duration, music segments, lyrics, genre, and artist;
wherein the step of matching and analyzing at least one movement instruction unit sequentially comprises:
obtaining an ith segment with signals of rhythmic events/features, and searching for at least one succeeding movement instruction unit option to a pre-defined (i−1)th movement instruction unit;
obtaining a pre-determined movement energy-transition probability distribution for transitioning the (i−1)th movement instruction unit to its succeeding movement instruction unit (the ith movement instruction unit) based on the movement energy level of the (i−1)th movement instruction unit and a model/mechanism of varying/transitioning movement energy levels from one to another;
dynamically updating/adjusting the pre-determined movement energy-transition probability distribution described above for transitioning the (i−1)th movement instruction unit to its succeeding movement instruction unit (the ith movement instruction unit) when variable measurements or quantification of music energy/audio signals and user performance data are received;
determining the energy level of the succeeding movement instruction unit option to the (i−1)th movement instruction unit based on the movement energy-transition probability distribution for transitioning the (i−1)th movement instruction unit to its succeeding movement instruction unit (the ith movement instruction unit);
selecting at least one succeeding movement instruction unit to the (i−1)th movement instruction unit as the ith movement instruction unit, according to the determined movement energy level of the (i−1)th movement instruction unit, or the persona and user behavior pattern;
wherein i is an integer ranging from 2 to N, and N is a number of the segment with signals of rhythmic events/features in the timeseries/sequence with signals of rhythmic events/features.

6. The exercise method according to claim 3, wherein, the generated exercise guiding video is the first exercise guiding video, the exercise guiding video is generated by:
determining an instructor object and generating the first exercise guiding video according to the movement instruction sequence and the instructor object, wherein the instructor object is a virtual instructor or a real instructor; or,
determining a virtual scene/stage or extended reality generated by CGA, and generating the first exercise guiding video according to the movement instruction sequence and the virtual scene/stage or extended reality generated by CGA, wherein the virtual scene/stage or extended reality generated by CGA has dynamically varying effects corresponding to the movement instruction sequence to improve engagement and immersiveness.

7. The exercise method according to claim 6, wherein, the instructor object is determined by matching and analyzing the virtual instructor or the real instructor according to the music information/audio signal of the selected music input/audio signal and/or the persona and user behavior pattern; or, determining the virtual instructor or the real instructor according to a user selection;
the virtual scene/stage or extended reality generated by CGA is determined by matching and analyzing the virtual scene/stage or extended reality generated by CGA according to the music information/audio signal of the selected music input/audio signal and/or the persona and user behavior pattern.

8. The exercise method according to claim 3, wherein, the generated exercise guiding video is the second exercise guiding video, the exercise guiding video is generated by:
generating a movement instruction/cuing list according to the movement instruction sequence;
playing the movement instruction/cuing list and the selected music input/audio signal;
receiving a recorded video as a pre-determined second exercise guiding video, wherein the pre-determined second exercise guiding video comprises a front layer including an instructor object and a recorded background, the recorded background is a green screen, and the instructor object of the front layer is a real instructor;
obtaining the second exercise guiding video by extracting the front layer including the instructor object from the pre-determined second exercise guiding video.

9. The exercise method according to claim 1, wherein, the CGA and the special-effect/animated feedbacks are generated by:
matching, analyzing, integrating and synchronizing the CGA and special-effect/animated feedbacks according to the music information/audio signal of the selected music input/audio signal and/or the persona and user behavior pattern.

10. The exercise method according to claim 9, wherein, the step of playing the exercise guiding video, the CGA, the special-effect/animated feedbacks and the selected music input/audio signal further comprises:
updating and rendering the CGA and/or the special-effect/animated feedbacks according to the received user performance data.

11. The exercise method according to claim 1, wherein, the user performance data comprises user performance data, the musical characteristics of the selected music input/audio signal comprises a timeseries/sequence with signals of rhythmic events/features, the timeseries/sequence with signals of rhythmic events/features comprises a plurality of segments with signals of rhythmic events/features;
wherein the step of displaying interactive feedback data comprises:
determining whether the user performance data coincides or synchronizes with the segment with signals of rhythmic events/features of a corresponding time;
if yes, displaying a combo-strike effect;
if no, displaying a special-effect/animated feedback showing “missing” or not displaying any special-effect/animated feedback on the display and computing device.

12. The exercise method according to claim 11, wherein, the step of displaying interactive feedback data further comprises:
determining whether a user performance level should be raised or not according to a number of continuous displays of the combo-strike effect or a cumulative number of displays of the combo-strike effect;
if no, displaying a special-effect/animated feedback corresponding to no upgrading/leveling-up or not displaying any special-effect/animated feedback on the display and computing device;
if yes, displaying a special-effect/animated feedback corresponding to upgrading/leveling-up on the display and computing device, calculating a performance score of the user according to the user performance data, and displaying the performance score on the display and computing device.

13. The exercise method according to claim 12 further comprising:
establishing a virtual room or arena, and playing a same selected music input/audio signal, and the exercise guiding video, the CGA, the special-effect/animated feedbacks generated according to the same music input/audio signal on display and computing devices of the user and other users in the virtual room or arena;
receiving the user performance data;
calculating the performance score of the user according to the user performance data;
receiving the performance scores of the other users in the virtual room or arena;
displaying, in a leaderboard display area on the display and computing device, the performance scores calculated at a same timing and location of the selected music input/audio signal of the user and other users in the virtual room or arena in a sequence from large to small;
wherein, the displayed sequence of the performance scores is dynamically updated according to the variation of the performance scores.

14. The exercise method according to claim 11, wherein, the step of receiving user performance data comprises:
receiving the user performance data from bike sensor devices of an exercise bike, wherein the user performance data comprises one or more of cadence, resistance, whether the user is on or out of the bike saddle, and heart rate tracked and collected by the bike sensor devices.

15. The exercise method according to claim 11, wherein, the step of receiving user performance data comprises:
receiving the user performance data from accessory sensor devices of an exercise accessory, wherein the user performance data comprises one or more of angular rates, linear velocity, position, and heart rate tracked and collected by the accessory sensor devices.

16. The exercise method according to claim 11, wherein, the step of receiving user performance data comprises:
receiving video stream of the user movements from a video capturing device;
identifying the user performance data according to the video stream of the user, wherein the user performance data comprises one or more of angular rates, linear velocity and position identified from the video stream.

17. The exercise method according to claim 11, wherein, the step of receiving user performance data comprises:
determining a user exercise mode, wherein the user exercise mode includes an exercise bike mode, an exercise accessory mode, and a computer vision mode;
if the user exercise mode is the exercise bike mode, receiving the user performance data from bike sensor devices of an exercise bike;
if the user exercise mode is the exercise accessory mode, receiving the user performance data from accessory sensor devices of an exercise accessory;
if the user exercise mode is the computer vision mode, receiving video stream of the user movements from a video capturing device; and identifying the user performance data from the video stream.

18. The exercise method according to claim 1, wherein, the user performance data comprises accessory performance data, the step of displaying interactive feedback data comprises:
displaying the accessory performance data and/or energy consumption data on the display and computing device, wherein the energy consumption data is calculated according to at least the accessory performance data, wherein the accessory performance data comprises one or more of heart rate, exercise duration, and exercise intensity of the user.

19. An exercise equipment comprising:
an exercise bike provided with multiple bike sensor devices, wherein the bike sensor devices are configured to track and collect user performance data;
a display and computing device configured to play videos and audios, and process programs and algorithms;
a control device configured to:
receive an exercise guiding video determined according to a selected music input/audio signal, wherein the exercise guiding video comprises a first exercise guiding video and/or a second exercise guiding video, the first exercise guiding video is a live video generated automatically according to the selected music input/audio signal, the second exercise guiding video is a video previously recorded according to the selected music input/audio signal;
receive CGA and special-effect/animated feedbacks;
control the display and computing device to display the exercise guiding video, the CGA, the special-effect/animated feedbacks and the selected music input/audio signal;
receive the user performance data from the bike sensor devices;
receive interactive feedback data generated or updated according to a result obtained by matching the user performance data with music information/audio signal analyzed from selected music input/audio signal;
control the display and computing device to display the interactive feedback data.

20. An exercise equipment comprising:
a first exercise device provided with first sensor devices, wherein the first sensor devices are configured to track and collect first user performance data;
a second exercise device provided with second sensor devices, wherein the second sensor devices are configured to track and collect second user performance data;
a display and computing device configured to play videos and audios, and process programs and algorithms;
a control device configured to:
receive an exercise guiding video determined according to a selected music input/audio signal, wherein the exercise guiding video comprises a first exercise guiding video and/or a second exercise guiding video, the first exercise guiding video is a live video generated automatically according to the selected music input/audio signal, the second exercise guiding video is a video previously recorded according to the selected music input/audio signal;
receive CGA and special-effect/animated feedbacks;
control the display and computing device to display the exercise guiding video, the CGA, the special-effect/animated feedbacks and the selected music input/audio signal;
determine whether a first exercise mode or a second exercise mode is selected, according to a rotation angle of the display and computing device;
if the first exercise mode is selected:
receive the first user performance data from the first sensor devices;
receive first interactive feedback data generated or updated according to a matching and analyzing result between the first user performance data and music information/audio signal of the selected music input/audio signal;
control the display and computing device to display the first interactive feedback data;
if the exercise mode is the second exercise mode:
receive the second user performance data from the first sensor devices;
receive second interactive feedback data generated or updated according to a matching and analyzing result between the second user performance data and music information/audio signal of the selected music input/audio signal;
control the display and computing device to display the second interactive feedback data.
